(19) United States
(12) Patent Application Publication
(10) Pub. No.: US 2019/0106186 A1
(43) Pub. Date: Apr. 11, 2019

(54) TANK SUPPORT

(71) Applicant: Aqua Lung America, Inc., Vista, CA (US)

(72) Inventor: David SULLIVAN, Vista, CA (US)

(21) Appl. No.: 16/155,671

(22) Filed: Oct. 9, 2018

Related U.S. Application Data
(60) Provisional application No. 62/570,005, filed on Oct. 9, 2017.

(51) Int. Cl. B63C 11/22; F17C 13/08

(52) U.S. Cl. CPC B63C 11/2245; F17C 13/084; B63C 2011/026; F17C 2205/018; F17C 2270/0781; F17C 2205/0126

(57) ABSTRACT

This disclosure relates to tank wedge connectors to support cylindrical objects, for example to support scuba tanks, particularly designed for use in underwater operations on swimming and diving gear. An embodiment of the tank wedge connectors includes arranging the tank wedge connectors in an opposing pair, forming a cradle. Another embodiment of the disclosed tank wedge connectors includes a rail component which the wedge connectors can slide on to separate and expand, with one of the rails including detents for the wedges to be positioned and fixed at a desired spacing. A third embodiment of these tank wedge connectors includes being mounted to a flexible surface which allows the connectors to conform to cylindrical objects of varying radii.

### CROSS-REFERENCE TO RELATED APPLICATIONS

This application claims the benefit under 35 U.S.C. § 119(e) of the following U.S. provisional patent application, which is incorporated by reference herein:

U.S. Provisional Patent Application No. 62/570,005, filed Oct. 9, 2017, and entitled “SYSTEMS AND DEVICES INCORPORATING A NOVEL MODULAR CONNECTOR,” by Sullivan et al. (Attorney Docket 239717.000172.ALUNG26PRV).

### FIELD OF THE INVENTION

This disclosure relates to tank wedge connectors to support cylindrical objects, for example to support a scuba tank, particularly designed for use in underwater operations on swimming and diving gear.

### BACKGROUND

Scuba divers commonly use various type of cylindrical compressed air tanks. Scuba diving tanks are available in several standard sizes, ranging from 5 to 8 1/4 inches in diameter. The amount of air a scuba diver will use during a dive varies depending on the depth and temperature of his dive. On average, a scuba diver will use a full tank of air in 30-40 minutes. Scuba divers ordinarily utilize a buoyancy compensator device which includes an assembly for harnessing the scuba tank to their back during a dive.

Known methods for securing the scuba tank to a diver include a one-piece cradle in the specific size of the scuba tank to be used which is attached to the buoyancy compensator device that, in conjunction with a tank strap, affixes the tank to the buoyancy compensator device. Another is using the tank strap that secures the tank to the buoyancy compensator device woven through slots on the buoyancy compensator device. There are disadvantages related to both of these methods. The one-piece cradle is limiting in size and adds bulk and weight. The tank strap with slots method can be uncomfortable and lacks the stability of the cradle.

Thus, there is a need for a tank support that can be used optimally with scuba tanks of various diameters.

Therefore, it is an objective of this disclosure to provide an embodiment of a tank support consisting of two identical wedges, arranged in an opposing pair to form a cradle. Such a tank support can be used with a scuba tanks of various diameters.

### SUMMARY

A wedge connector for engaging a radiused object includes two supports positioned in opposition to form a cradle. Each of the supports consists of a substantially flat base, a slot, and a curved upper surface. The wedge connector may include a slot which is predominately curved. The curved-shape upper surface of each support may also have a radius to accept an object to be supported. The object may be a tank having a radius and length such as a scuba tank. The wedge connector may also include an area of reduced thickness around the perimeter of the wedge connector or around the base of the wedge connector. The wedge connector may include a slide having detents onto which the supports are positioned providing adjustment of the distance between the supports. The slide may include two rails with one of the rails having ridges to control the adjustment of the distance between the supports. The slide may also provide locking engagement of the supports to fix the distance between the supports. An alternate embodiment may include the supports being positioned on and affixed to material that is flexible . This flexure allows the supports to conform to the precise diameter of the cylinder, and are retained in this configuration by the tightened tank strap.

### BRIEF DESCRIPTION OF THE DRAWINGS

FIG. 1 is a top perspective exterior view of a tank wedge component.

FIG. 2 is a top perspective interior view of a tank wedge component.

FIG. 3 is a side view of two tank wedge components arranged in cradle formation, which are attached to a buoyancy compensator device, supporting a scuba tank.

FIG. 4 is a top view of two tank wedges positioned on an adjustable slide.

FIG. 5 is a side view schematic of two tank wedge components arranged in cradle formation showing the flexure accommodating different sized cylinders.

### DETAILED DESCRIPTION

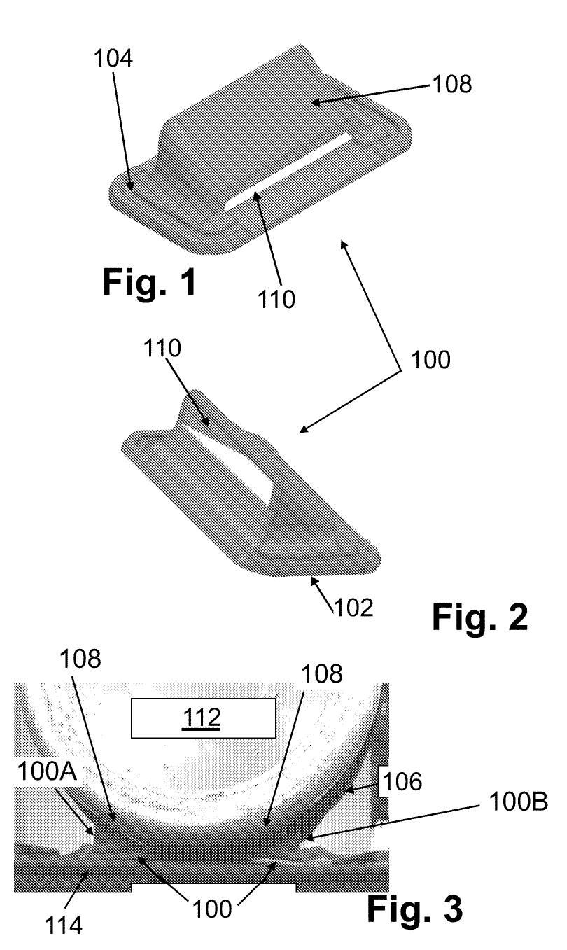

Referring to FIGS. 1-3, one embodiment of a tank wedge component (100) provides a support and attachment structure for a cylinder-shaped object (112), such as a cylindrical tank including a scuba tank, to a buoyancy compensator device (114). Such support and attachment is accomplished without a bulky tank pack. Wedge component (100) typically includes two identical pieces (100A, 100B) arranged into an opposing pair. Each tank wedge component (100A, 100B) consists of a flat base (102), a curved-shape slot (110), and a curved upper surface (108). Each wedge component (100A, 100B) includes a flat base (102), which benefits from relative flatness because relative flatness matches the body shape of the lumbar area of the scuba diver wearing the buoyancy compensator device (114). The slot (110) functions to allow a traditionally configured tank attachment strap (106) to be used to secure a scuba cylinder (112) to the pair of wedge connectors (100A, 100B). The slot (110) can be straight but is preferred to have a curved aspect matching the upper curved surface (108) of each wedge component (100A, 100B). Such curvature is preferred as the closer the traditional tank attachment strap (106) follows the scuba cylinder's shape (112), the more secure the connection. Each wedge component (100A, 100B) may also include a thin area (104) configured to ease the attachment process through the preferred attachment method of sewing. It is most preferred that in the present embodiment, that wedge components (100A, 100B) are formed of a substantially rigid material such as nylon. However, wedge components (100A, 100B) may also be constructed of any flexible material that would allow attachment to a buoyancy compensator device.

Referring to FIG. 3, as mentioned above, wedge components (100A, 100B) are preferred to be used in opposing pairs. The pair of curved upper surfaces (108) are positioned such that they form a type of cradle which conforms to the cylindrical shape of the tank, including the scuba cylinder (112). A particular benefit to this configuration is that since the modular connectors are typically mounted onto a moderately flexible surface of the buoyancy compensator device (114), it allows the assembly to conform to the scuba cylinder (112) for maximum support. This is beneficial as there are several different diameters of scuba cylinder in use today. The use of these wedge components (100A, 100B) allow objects with different radii and lengths to be used on the same buoyancy compensator device. Prior art designs that do not use tank packs have only used flat constructions, which are typically pieces of webbing sewn down at both ends to form channels for the tank attachment strap. Drawbacks to these designs is that as a consequence of causing a buoyancy compensator device, such as buoyancy compensator device (114), to conform to the scuba cylinder it forces the buoyancy compensator device into a shape contrary to the shape of the back of the scuba diver and thus an uncomfortable situation. Thus, the connectors disclosed generate all of the comfort and stability benefits of a standard pack configuration, with all the benefits of a web channel construction, such as cylinder conformity and minimal bulk and weight. Another embodiment may use only one tank wedge formed as a cradle, particularly if the scuba cylinder has a particularly small radius or is of particularly light weight.

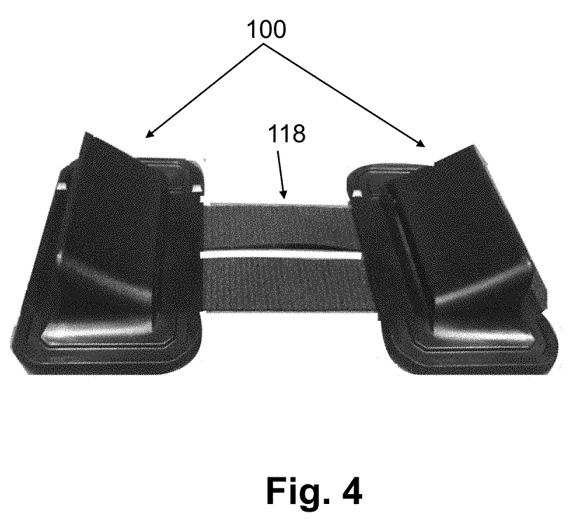

Referring to FIG. 4, another embodiment of these tank wedges includes an expandable sliding component (118). This sliding component may include an adjusting device such as rails, with the adjusting device or at least one rail having detents to which the wedges can lock into place to fix the distance between the two wedges.

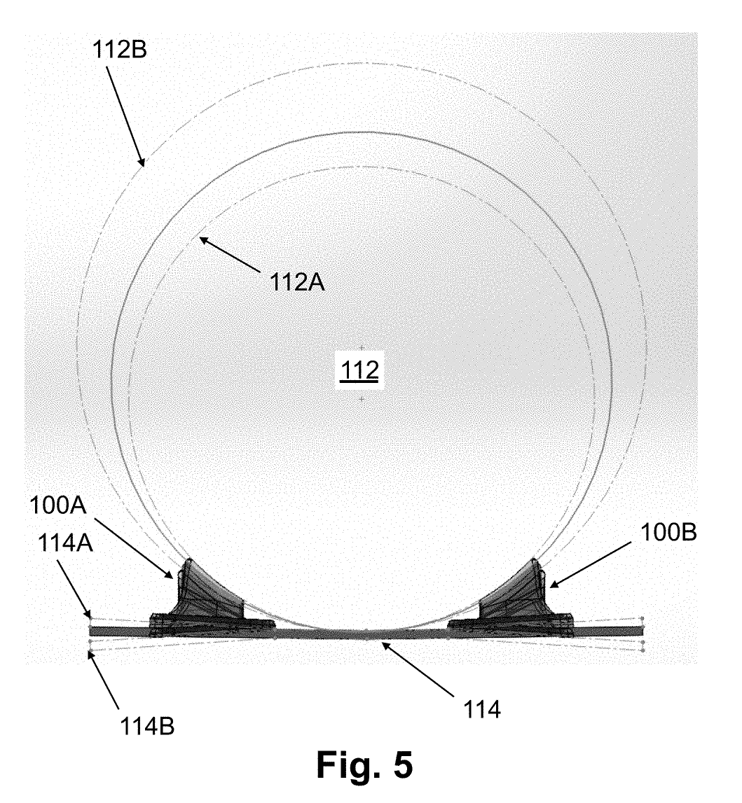

Referring to FIG. 5, several typical diameters of scuba cylinder are represented by three tangent circles (112, 112A and 112B). The flexible portion of the buoyancy compensator device (114) is depicted, by virtue of its flexibility, to allow the tank wedges to displace and thus conform to the diameter of whatever scuba cylinder is attached to the buoyancy compensator. Two example positions are indicated by 114A and 114B.

Reference throughout this specification to “the embodiment,” “this embodiment,” “the previous embodiment,” “one embodiment,” “an embodiment,” “a preferred embodiment” “another preferred embodiment” or similar language means that a particular feature, structure, or characteristic described in connection with the embodiment is included in at least one embodiment of the present invention. Thus, appearances of the phrases “in the embodiment, “in this embodiment,” “in the previous embodiment, in one embodiment, in an embodiment,” “in a preferred embodiment,” “in another preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. While the present invention has been described in connection with certain exemplary or specific embodiments, it is to be understood that the invention is not limited to the disclosed embodiments, but, on the contrary, is intended to cover various modifications, alternatives, modifications and equivalent arrangement as will be apparent to those skilled in the art. Any such changes, modifications, alternative, equivalents and the like may be made without departing from the spirit and scope of the disclosure.

What is claimed is:

1. A wedge connector for engaging a radiused object, comprising two supports positioned in opposition to form a cradle; each support consisting of a substantially flat base, a slot, and a curved upper surface.

2. The wedge connector of claim 1, wherein the slot is predominantly curved

3. The wedge connector of claim 2 wherein there is an area of reduced thickness around the perimeter.

4. The wedge connector for engaging a radiused object of claim 3, wherein the curved-shape upper surface of each support has a radius to accept an object to be supported.

5. The wedge connector for engaging a radiused object of claim 3, wherein the object to be supported is a tank having a radius and length.

6. The wedge connector for engaging a round object of claim 5, wherein the tank is a scuba tank.

7. The wedge connector for engaging a radiused object of claim 3 further including a slide having detents onto which the supports are positioned providing adjustment of a distance between the supports.

8. The wedge connector for engaging a radiused object of claim 7 wherein the slide includes two rails and at least one rail having ridges to control the adjustment of the distance between the supports.

9. The wedge connector for engaging a radiused object of claim 7 wherein the slide provides locking engagement of the supports to fix the distance between the supports.

10. The wedge connector for engaging a radiused object of claim 1 wherein the supports are made of a flexible material.

11. The wedge connector for engaging a radiused object of claim 3 wherein the supports are positioned on and affixed to material which is flexible and allows the supports to conform to various objects.

12. A wedge connector for positioning a tank, comprising two identical supports positioned in opposition to form a cradle, each support consisting of a substantially flat base with an area of reduced thickness around the perimeter and a radiused upper surface to engage a portion of the tank.
